(19) United States
(12) Patent Application Publication
(10) Pub. No.: US 2012/0043446 A1
(43) Pub. Date: Feb. 23, 2012

(54) Revolving and Translating Tool Base

(75) Inventors: Flip Britton, Chester Springs, PA (US); Dick Stemp, Kempton, PA (US)

(73) Assignee: Azer Scientific Inc., Morgantown, PA (US)

(21) Appl. No.: 12/868,943

(22) Filed: Aug. 26, 2010

Related U.S. Application Data
(60) Provisional application No. 61/374,611, filed on Aug. 17, 2010.

(51) Int. Cl. F16M 13/00

(52) U.S. Cl. 248/349.1

(57) ABSTRACT

A translating and rotating tool base for equipment and tools having a base plate that can be securely mounted to an existing work surface, a middle plate attached to the base plate by sliding rails so that the middle plate can translate relative to the base, and an upper mounting plate attached to the middle plate by a turntable so that the upper section can rotate relative to the middle plate. The middle and upper plates are movable fore and aft relative to the base plate to allow the equipment piece mounted to the top surface to be moved to a more accessible position. The upper plate can also rotate relative to the lower and middle plates to allow even greater access to the rear portion of the equipment piece mounted to the top plate.

### CROSS REFERENCE TO RELATED APPLICATIONS

The present invention claims priority to U.S. provisional patent application No. 61/374,611 filed Aug. 17, 2010 entitled Revolving and Translating Tool Base, which is incorporated herein by reference.

### FIELD OF THE INVENTION

The present invention relates to a rotating and translating tool base for movably supporting equipment and tools.

### BACKGROUND OF THE INVENTION

Diagnostic testing laboratories often have a large number and wide variety of high-cost, high-tech diagnostic equipment, which is used to streamline and automate standard testing procedures. In order to minimize the amount of expensive and valuable bench-top space occupied by such equipment, some testing equipment is tucked into tight areas. Because these areas provide little or no back and/or side access to the equipment, and because the equipment can be very heavy and difficult to move, service and routine maintenance of the equipment is inhibited and therefore often disregarded. Furthermore, movement of many types of delicate equipment should be minimized to avoid damage or calibration error to the equipment.

### SUMMARY OF THE INVENTION

The present invention relates to a movable tool base on which a variety of laboratory equipment or tools can be supported or mounted. The tool base mounts securely to an existing work surface, such as a laboratory bench top, and allows the equipment piece to be translated linearly fore and aft and rotated clockwise and counter-clockwise relative to the work surface. This linear and rotational freedom of motion allows the equipment mounted thereon to be tucked into a tight area on the work surface during normal use, and then easily moved, by sliding and rotating, from the tight area for servicing or maintenance. The tool base is designed using industrial grade hardware and components to allow very heavy items (up to 1000 lbs.) to be mounted thereon and moved safely.

In a preferred embodiment, the tool base has a bottom base plate, middle plate, and upper mounting plate. Slides connect the middle plate to the bottom base plate and enable the middle plate to translate linearly relative to the bottom base plate. A turntable connects the upper mounting plate to the middle plate and enables the upper mounting plate to rotate about a central axis relative to the middle plate. The tool base has a first limit position in which each of the plates are aligned one on top of the other, a second limit position in which the center of the middle and upper plates is aligned with the front edge of the bottom base plate, and a third limit position in which the upper mounting plate is rotated about the central axis relative to the middle and bottom base plate. The plates can be arranged in a plurality of positions intermediate the first, second and third limit positions.

The middle plate includes a plurality of walls extending downwardly and enclosing the slides. Means, such as seismic straps, are provided for removably fastening the equipment piece to the upper mounting plate. An optional level is provided for leveling the tool base prior to fastening the tool base to the work surface. Preferably an anti-microbial finish covers each of the bottom, middle and upper plates.

Means are provided for preventing the middle plate from translating past the second limit position and for preventing the upper plate from rotating past the third limit position. In a preferred embodiment, rotation of the upper plate is limited to about 100 degrees in either the clockwise or counter-clockwise direction.

The present invention also relates to a method of supporting and providing access to an equipment piece on a work surface by providing a rotating and translating tool base having a lower base plate and a plurality of upper plates that translate and/or rotate relative to the base plate. The tool base is initially positioned, leveled and then secured to the back of the work surface. The equipment piece is mounted to the tool base. When maintenance or service to the equipment is needed, the tool base and equipment are translated toward the front of the work surface and then rotated relative to the work surface to give easy access to the sides and back of the equipment. Forward translation is limited so that the center of gravity of the equipment does not cantilever out from the lower base plate. Rotation of the equipment is also limited to about 100 degrees in either the clockwise or counter-clockwise direction to prevent severing or damage to power or data connections. Contamination of the tool base is prevented by coating the tool base with an anti-microbial finish.

### BRIEF DESCRIPTION OF THE DRAWINGS

FIG. 1 is a perspective view of a movable tool base in accordance with an embodiment of the invention shown in a first limit position;

FIG. 2 is a perspective view of the tool base of FIG. 1 shown in a second limit position;

FIG. 3 is a perspective view of the tool base of FIG. 1 shown in a second limit position with the upper plate also rotated;

FIG. 4 is an exploded perspective of the tool base shown in FIG. 1;

FIG. 5 is another exploded perspective of the tool base shown in FIG. 1;

FIG. 6 is a perspective view of the movable tool base of FIG. 1 in the second/open limit position and rotated with an equipment piece installed thereon; and,

FIG. 7 is fragmentary, enlarged perspective view of the seismic strap attachment nuts of FIG. 6. \

### DETAILED DESCRIPTION OF PREFERRED EMBODIMENT(S)

For the purpose of illustration only, an embodiment of the invention is shown in the accompanying drawings. However, it should be understood by those of ordinary skill in the art that the invention is not limited to the precise arrangements and instrumentalities shown therein and described below. Throughout the specification, like reference numerals are used to designate like elements. Numerous changes and modifications within the spirit and scope of the invention will become apparent to those skilled in the art from this detailed description.

Unless otherwise defined, all technical and scientific terms used herein in their various grammatical forms have the same meaning as commonly understood by one of ordinary skill in the art to which this invention belongs.

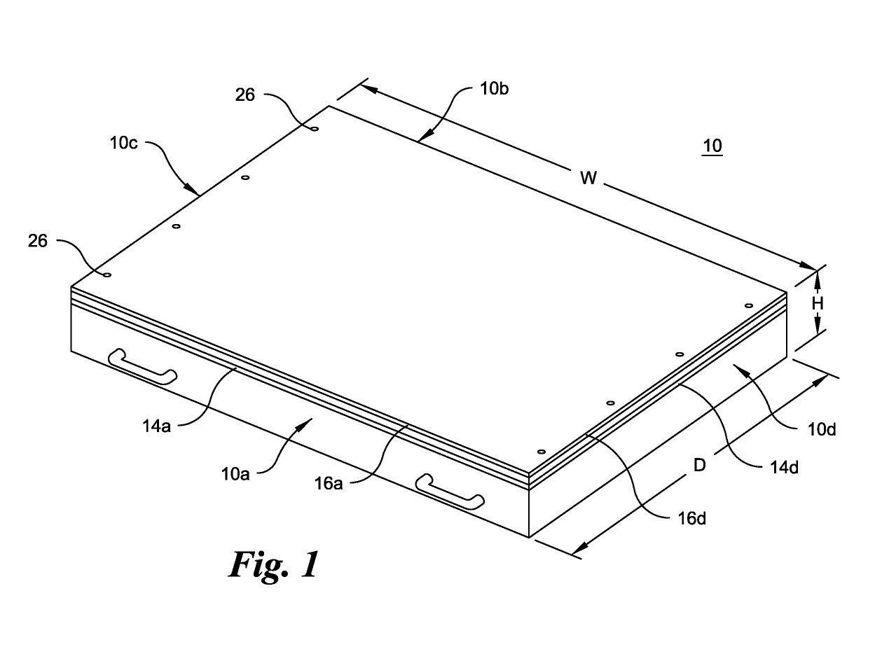

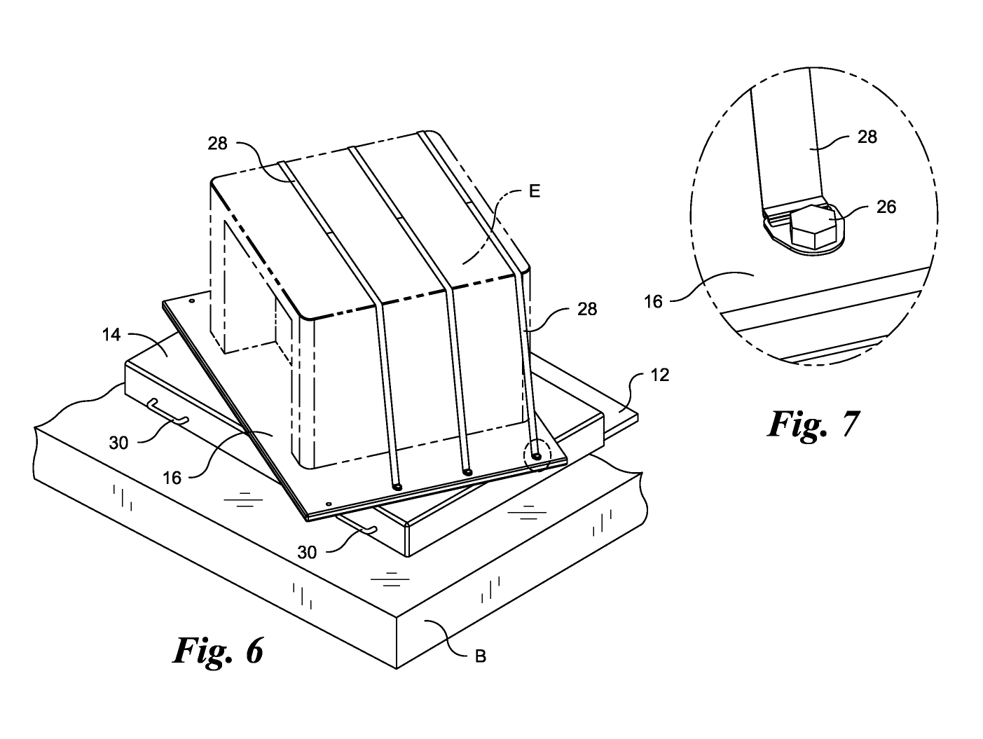

A tool base in accordance with an embodiment of the invention is shown in FIGS. 1-7 and is designated generally by reference numeral 10. The tool base 10 of this embodiment is illustrated and described below with reference to supporting a piece of testing equipment “E”, such as a hematology analyzer, on a laboratory work bench “B” as shown in FIG. 6. However, it should be understood by those of ordinary skill in the art that the tool base 10 can be used for mounting a wide variety of tools or equipment pieces in a variety of work settings.

The tool base 10 generally comprises a lower base plate 12, a middle plate 14 and an upper mounting plate 16. A pair of slides 18 connects the middle plate 14 to the bottom base plate 16 and enables the middle plate 14 to translate linearly relative to the bottom base plate 12. A turntable 20 connects the upper mounting plate 16 to the middle plate 14 and enables the upper mounting plate 16 to rotate relative to the middle plate 14. The base plate 12 rests on and is preferably fixed to a work surface such as, for example, a laboratory work bench or table top “B” best seen in FIG. 6. The upper mounting plate 16 supports, and is preferably fixed to, a piece of equipment “E” such as laboratory testing equipment.

In the embodiment shown in FIGS. 1-7, the tool base 12 has a generally rectangular shape and is large enough to support a variety of equipment or tools. In a preferred embodiment, the width “W” of the tool base may vary from about 30 inches to about 48 inches. The depth “D” of the tool base is preferably about 24 inches. The depth “D” of the tool base may also vary but is somewhat restricted due to the customary depth of the laboratory bench tops on which the tool base 12 may be mounted. In a preferred embodiment, the height (H) of the tool base 10 is minimized to about 5 inches so as not to excessively elevate the equipment piece “E”.

The tool base 12 has a front side 10a, back side 10b, left side 10c and right side 10d. Similarly, each base plate 12, 14, 16 has corresponding aligned front 12a, 14a, 16a, back 12b, 14b, 16b, left 12c, 14c, 16c, and right 12d, 14d, 16d sides, respectively, when the tool base 12 is configured in the first or closed limit position shown in FIG. 1. As best seen in FIGS. 1-3, the upper plate 12 and middle plate 14 have chamfered edges to reduce the risk of injury to the operator.

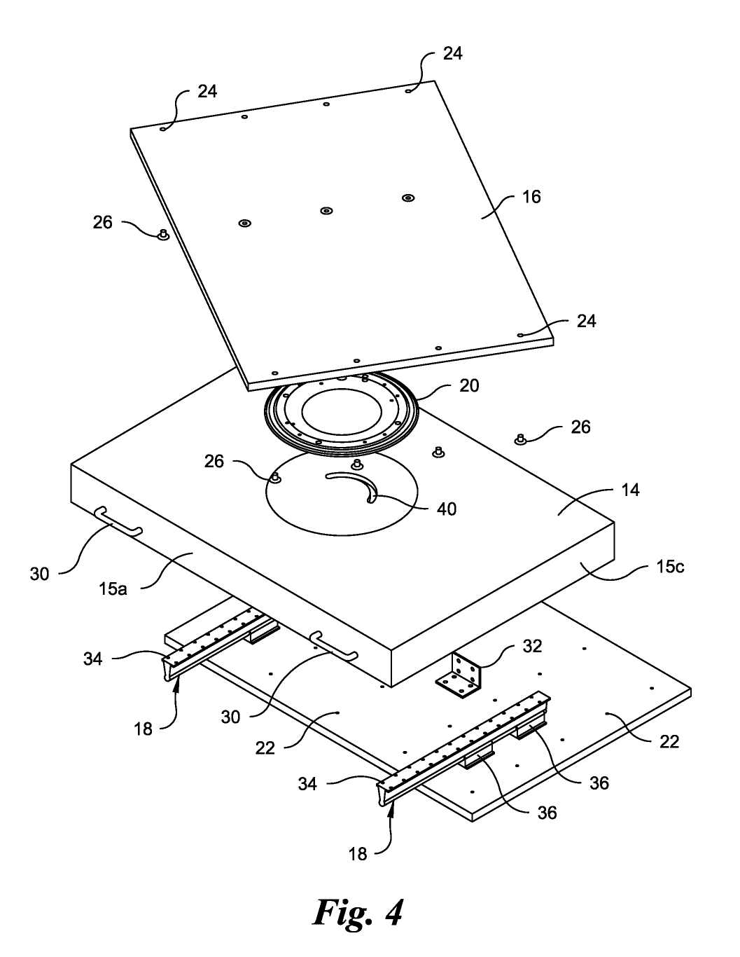

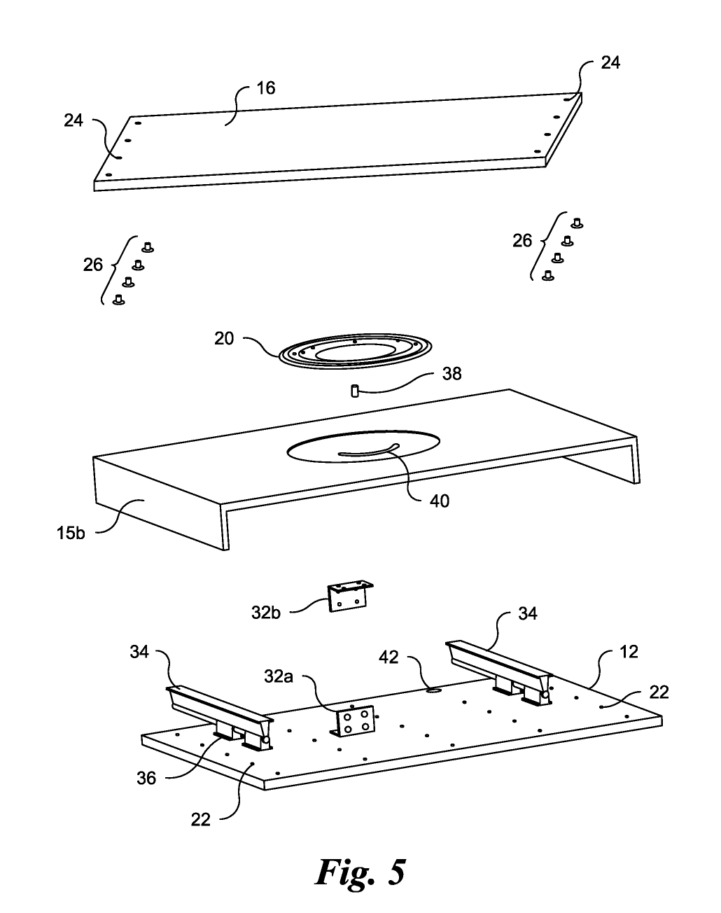

As best seen in FIGS. 4 and 5, the lower base plate 12 and upper mounting plate 16 have a generally-rectangular, planar configuration. The lower plate 12 includes a plurality of apertures 22 through which fasteners can be inserted to affix the lower plate to a work surface. The upper plate 16 also includes a plurality of apertures 24 in which seismic strap attachment nuts 26 are fixed. In a preferred embodiment, the equipment piece “E” is attached to the upper mounting plate with seismic straps 28, which fasten to the attachment nuts 26 as best seen in FIGS. 6 and 7.

In contrast with the lower 12 and upper 16 plates, the middle plate includes front 15a, left side 15b and right side 15d walls, which extend downwardly just short of contacting the lower base plate 12. The side walls 15, together with the middle plate 14, form an enclosure that conceals the slides 18 and prevents foreign objects from interfering with movement of the slides 18. The front wall 15a also provides a surface to which optional handles 30 may be mounted. All three side walls 15 also increase the rigidity of the middle plate.

The lower 12, middle 14, and upper 16 base plates may be made of any rigid material having sufficient strength to support the intended equipment pieces. Preferably, the material is one that can be easily cleaned and sterilized and which is resistant to bacterial growth. In the embodiment shown in FIGS. 1-7, the plates are made from medium density fiberboard (“MDF”) having a powder coated finish with an antimicrobial additive such as sold by Protech Powder Inc. The coating should preferably resist heat, moisture, chemical attack.

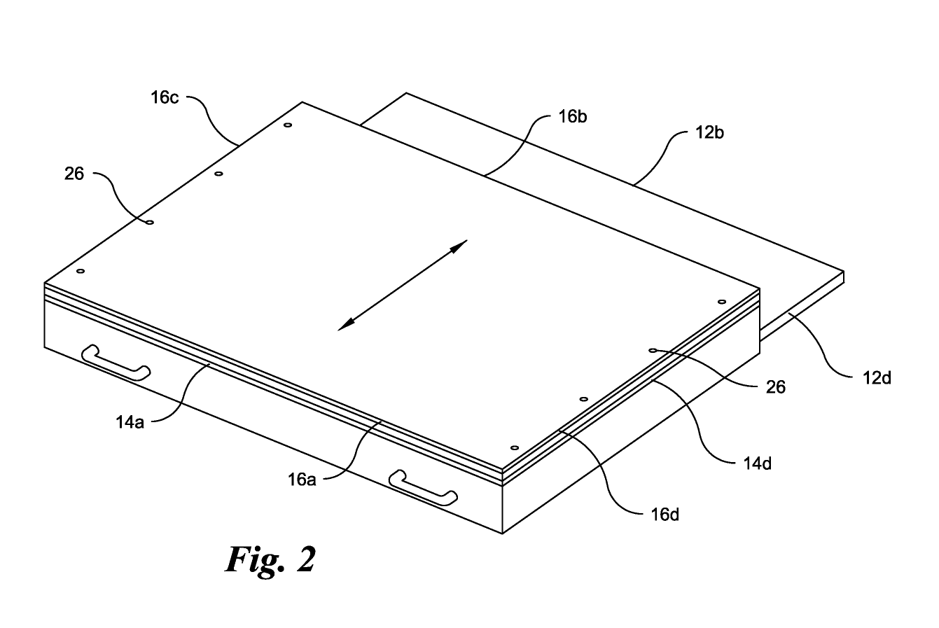

The slides 18 allow the middle plate 14 to translate linearly relative to the lower base plate 12. In a preferred embodiment, the middle plate 14 translates fore and aft in the direction shown by the direction arrow in FIG. 2. In the embodiment shown in FIGS. 1-7, each slide 18 comprises a linear rail 34 slidably mounted in a pair of spaced pillow blocks 36. The rail 34 is fixed to the underside of the middle plate 14 and the pillow blocks 36 are fixed to the upper side of the lower base plate 12. Alternatively, the slides 18 may comprise well-known, commercially-available roller rack assemblies.

Since the slides 18 will directly support the weight of the equipment piece, they should be heavy duty and precision to ensure smooth operation. The slides 18 should also preferably be made of a corrosion resistant material to withstand attack in a laboratory environment. In one preferred embodiment, the rails 34 comprise type WSS ½″ stainless steel rail with an aluminum base 12″ to 24″ in length. In one embodiment, the pillow blocks 36 comprise ½″ open type TWD.

First and second cooperating linear stops 32a, 32b are fixed to the upper side of the lower base plate 12 and the underside of the upper plate 16, respectively, as best seen in FIGS. 4 and 5 to limit the range of travel of the middle plate 14. In this embodiment, the linear stops 32a, 32b comprise “L” brackets that are positioned to abut one another when the middle plate 14 reaches the second limit position shown in FIG. 2. The transversely protruding portions of the “L” brackets abut one another when the middle plate 14 reaches the second limit position. In a preferred embodiment, the linear stops 32a, 32b are positioned such that the center of the upper mounting plate 16 does not extend past or cantilever over the front edge 12a of the lower base plate 12. Assuming the equipment piece “E” is centered on the upper mounting plate 16, the linear stops 32a, 32b prevent the center of gravity of the equipment piece “E” from extending beyond the front edge 12a of the lower base plate 12, which would create a tipping force on the tool base 10.

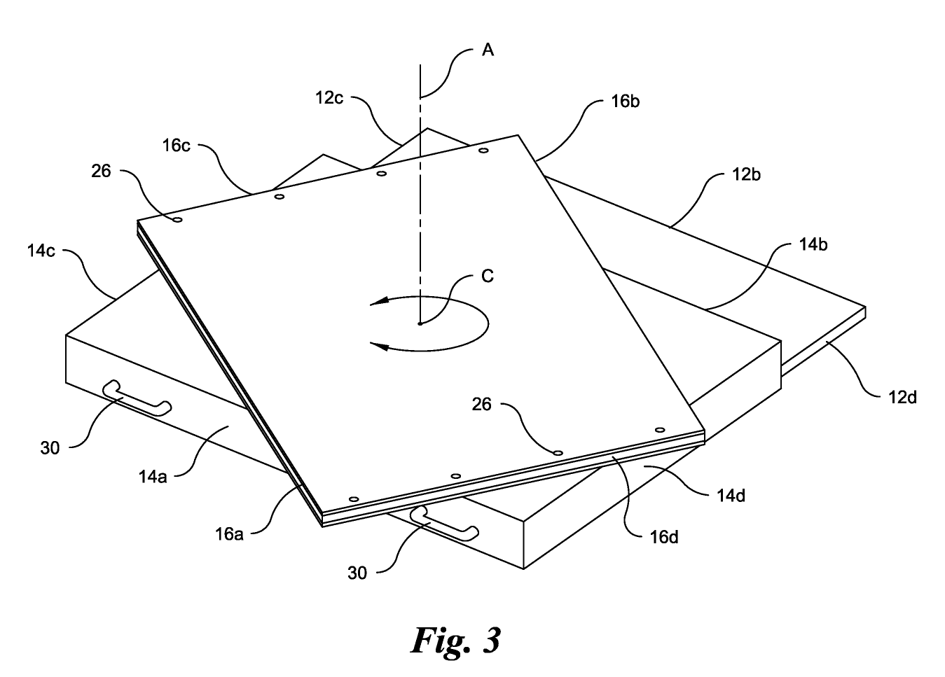

The turntable 20 enables the upper mounting plate 16 to rotate relative to the middle plate 14. Referring to FIG. 3, the upper mounting plate 16 revolves about an axis “A” that runs through the center “C” of the plate and is generally orthogonal to the plane of the upper mounting plate 16 (hereinafter its “central axis”). In the embodiment shown in FIGS. 1-7, the turntable comprises a commercially-available turntable such as sold by McMaster Carr Supply Company, Elmhurst, Ill. Since the turntable 20 will directly support the weight of the equipment piece “E”, it should preferably have heavy duty bearings to ensure smooth operation. The turntable 20 may also include integrated detents that bias the upper mounting plate 16 to predefined angular positions. The detents help maintain the equipment piece in place while it is being serviced. The turntable 20 should also preferably be made of a corrosion resistant material to withstand attack in a laboratory environment.

In a preferred embodiment, the tool base 10 also includes stops that limit the rotational travel path of the upper mounting plate 16. As best seen in FIGS. 4 and 5, the tool base 10 includes a rotational stop pin 38 fixed to the underside of the upper mounting plate 16. The stop pin 38 rides in an arcuate slot 40 formed in the middle plate 16. The length (degrees of rotation) of the slot 40 is about 200 degrees in the embodiment shown in FIGS. 1-7 but may be shortened or lengthened to suit particular applications. The rotational stop will help prevent power plugs or data connections in the back of the equipment from being disconnected, damaged or severed.

In a preferred embodiment, the tool base 10 is mounted on a work bench in close proximity to other equipment or other tool bases 10. This tight arrangement allows the operator to maximize the amount of equipment docked on the bench top. Under normal operating conditions, the tool base 10 will be configured in the closed or first limit position shown in FIG. 1 with an equipment piece mounted thereon. If and when the equipment piece requires maintenance or service, the operator slides the equipment piece forward toward him/her until the tool base 10 reaches the open or second limit position shown in FIG. 2. In this position, the technician can easily access the sides and back of the equipment. To more easily access the back of the equipment, the equipment piece can also be rotated clockwise or counterclockwise to a third limit position such as shown in FIG. 3. The equipment piece “E” is preferably moved by grasping and manipulating the handles 30 of the tool base 10 even though the equipment piece is strapped to the top mounting surface 16. Once the maintenance or service is complete, the equipment piece is returned to its original docking location by returning the tool base 10 to its closed position.

In the embodiment shown in FIGS. 1-7, the tool base 10 includes a built-in level to insure that the tool base is mounted in a level configuration to insure proper functioning. For example, the tool base 10 may unintentionally slide to the open limit position if the tool base is leaning forward, or may be excessively difficult to slide to the open position if the tool base is leaning backward. In a preferred embodiment, the level comprises a bulls-eye level 42 build into the base plate 12 as best seen in FIG. 5.

It is to be understood that the description, specific examples and data, while indicating exemplary embodiments, are given by way of illustration and are not intended to limit the present invention. Various changes and modifications within the present invention will become apparent to the skilled artisan from the discussion, disclosure and data contained herein, and thus are considered part of the invention. For example, it is possible to flip-flop the slides and the turn table so that the middle plate rotates relative to the base plate and the upper mounting plate linearly translates relative to the middle plate.

1. A rotating and translating tool base, comprising:
a) bottom base plate, middle plate, and upper mounting plate;
b) slides connecting said middle plate to said bottom base plate and enabling said middle plate to translate linearly relative to said bottom base plate; and,
c) a turntable connecting said upper mounting plate to said middle plate and enabling said upper mounting plate to rotate about a central axis relative to said middle plate;
wherein said tool base has a first limit position in which each of said plates are aligned one on top of the other, a second limit position in which the center of the middle and upper plates is aligned with the front edge of the bottom base plate, and a third limit position in which the upper mounting plate is rotated about the central axis relative to the middle and bottom base plate.

2. The tool base recited in claim 1, wherein the plates can be arranged at a plurality of locations intermediate the first, second and third limit positions.

3. The tool base recited in claim 1, wherein said middle plate includes a plurality of walls extending downwardly and enclosing said slides.

4. The tool base recited in claim 1, including seismic straps for removably fastening an equipment piece to the upper mounting plate.

5. The tool base recited in claim 1, including a level.

6. The tool base recited in claim 1, including means for preventing the middle plate from translating past the second limit position and means for preventing the upper plate from rotating past the third limit position.

7. The tool base recited in claim 1, including an anti-microbial finish covering each of said bottom, middle and upper plates;

8. A rotating and translating tool base for supporting an equipment piece, comprising:
a) bottom base plate, middle plate, and upper mounting plate;
b) slides connecting a first of said plates to a second of said plates and enabling the first plate to translate linearly relative to the second plate;
c) a turntable connecting the third of said plates to the second plate and enabling the third plate to rotate relative to the second plate about a central axis; and,
wherein said tool base has a first limit position in which each of said plates are aligned one on top of the other, a second limit position in which the center of two of said plates is aligned with the front edge of the third base plate, and a third limit position in which the one of said plates is rotated about the central axis relative to the other two plates.

9. The tool base recited in claim 8, including means for limiting translation and rotation of said plates past the limit positions.

10. A method of supporting and providing access to an equipment piece on a work surface, comprising the steps of:
a) providing a rotating and translating tool base having a lower base plate and a plurality of upper plates that translate and/or rotate relative to the base plate;
b) positioning the tool base near the back of the work surface;
c) mounting the equipment piece to the tool base;
d) translating the base and equipment piece toward the front of the work surface; and,
e) rotating the tool base and the equipment piece relative to the work surface.

11. The method recited in claim 10, including the steps of:
f) limiting translation of the tool base so that the center of gravity of the equipment does not cantilever out from the lower base plate.

12. The method recited in claim 11, including limiting rotation of the equipment piece to about 100 degrees in either the clockwise direction or counter-clockwise direction.

13. The method recited in claim 10, including the step of securing the tool base to the work surface.

14. The method recited in claim 13, including the step of leveling the tool base prior to securing it to the work surface.

15. The method recited in claim 10, including the step of preventing contamination of the tool base.

16. The method recited in claim 15, wherein said contamination preventing step comprises coating the tool base with an anti-microbial finish.
